(19) United States
(12) Patent Application Publication
(10) Pub. No.: US 2011/0218802 A1
(43) Pub. Date: Sep. 8, 2011

(54) Continuous Speech Recognition

(76) Inventors: Shlomi Hai Bouganim, Modiin (IL); Boris Levant, Rehovot (IL)

(21) Appl. No.: 12/719,140

(22) Filed: Mar. 8, 2010

(51) Int. Cl. G10L 15/04

(52) U.S. Cl. 704/211; 704/254; 704/E15.005

(57) ABSTRACT

A computerized method for continuous speech recognition using a speech recognition engine and a phoneme model. The computerized method inputs a speech signal into the speech recognition engine. Based on the phoneme model, the speech signal is indexed by scoring for the phonemes of the phoneme model and a time-ordered list of phoneme candidates and respective scores resulting from the scoring are produced. The phoneme candidates are input with the scores from the time-ordered list. Word transcription candidates are typically input from a dictionary and words are built by selecting from the word transcription candidates based on the scores. A stream of transcriptions is outputted corresponding to the input speech signal. The stream of transcriptions is re-scored by searching for and detecting anomalous word transcriptions in the stream of transcriptions to produce second scores.

### BACKGROUND

1. Technical Field

The present invention relates to speech recognition and particularly to a method of word transcription.

2. Description of Related Art

A conventional art speech recognition engine, typically incorporated into a digital signal processor (DSP), inputs a digitized speech signal, and processes the speech signal. The input speech signal is sampled, digitized and cut into frames of equal time windows or time duration, e.g. 25 millisecond window with 10 millisecond overlap. The frames of the digital speech signal are typically filtered, e.g. with a Hamming filter and then input into a circuit including a processor which performs a transform for instance a fast Fourier transform (FFT) using one of the known FFT algorithms.

Mel-frequency cepstral coefficients (MFCC) are commonly derived by taking the Fourier transform of a windowed excerpt of a signal to produce a spectrum. The powers of the spectrum are then mapped onto the mel scale, using the overlapping windows. Differences in the shape or spacing of the windows used to map the scale can be used. The logs of the powers at each of the mel frequencies are taken, followed by the discrete cosine transform of the mel log powers. The Mel-frequency cepstral coefficients (MFCCs) are the amplitudes of the resulting spectrum.

Conventional speech recognition systems employ probabilistic models known as hidden Markov models (HMMs). A hidden Markov model includes multiple states. A transition probability is defined for each transition from each state to every other state, including transitions to the same state. An observation is probabilistically associated with each unique state. The transition probabilities between states (the probabilities that an observation will transition from one state to the next) are not all the same. Therefore, a search technique, such as a Viterbi algorithm, is employed in order to determine a most likely state sequence for which the overall probability is maximum, given the transition probabilities between states and observation probabilities.

In conventional speech recognition systems, speech has been viewed as being generated by a hidden Markov process. Consequently, HMMs have been employed to model observed sequences of speech spectra, where specific spectra are probabilistically associated with a state in an HMM. In other words, for a given observed sequence of speech spectra, there is a most likely sequence of states in a corresponding HMM.

This corresponding HMM is thus associated with the observed sequence. This technique can be extended, such that if each distinct sequence of states in the HMM is associated with a sub-word unit, such as a phoneme, then a most likely sequence of sub-word units can be found. Moreover, using models of how sub-word units are combined to form words, then using language models of how words are combined to form sentences, complete speech recognition can be achieved.

Conventional speech recognition systems can typically be classified in two types. Continuous speech recognition (CSR) system which is capable of recognizing fluent speech and an isolated speech recognition (ISR) system which is typically employed to recognize only isolated speech (or discrete speech). The conventional CSR system is trained (i.e., develops acoustic models) based on continuous speech data in which one or more readers read training data into the system in a continuous or fluent fashion. The acoustic models developed during training are used to recognize speech.

The isolated speech recognition (ISR) system which is typically employed to recognize only isolated speech (or discrete speech). The conventional ISR system is typically trained (i.e., develops acoustic models) based on discrete or isolated speech data in which one or more readers are asked to read training data into the system in a discrete or isolated fashion with pauses between each word. An ISR system is also typically more accurate and efficient than continuous speech recognition systems because word boundaries are more definite and the search space is consequently more tightly constrained. Also, isolated speech recognition systems have been thought of as a special case of continuous speech recognition, because continuous speech recognition systems generally can accept isolated speech as well.

Conventional speech recognition systems of either type may index the input speech signal. During indexing, speech is processed and stored in a structure relatively easy to search known as an index. The input speech signal is tagged using a sequence of recognized words or phonemes. In the search stage, the index is searched and the exact location (time) of the target word is determined. An example of such an index is sometimes known as a phoneme lattice.

TIMIT is a corpus of phonemically and lexically transcribed speech of American English speakers of different sexes and dialects. Each transcribed element has been delineated in time. TIMIT was designed to further acoustic-phonetic knowledge and automatic speech recognition systems. It was commissioned by DARPA and worked on by many sites, including Texas Instruments (TI) and Massachusetts Institute of Technology (MIT), hence the corpus' name. The 61 phoneme classes presented in TIMIT can been further collapsed or folded into 39 classes using a standard folding technique by one skilled in the art.

In human language, the term “phoneme” as used herein is the smallest unit of speech or a basic unit of sound in a given language that distinguishes one word from another. An example of a phoneme would be the ‘t’ found in words like “tip”, “stand”, “writer”, and “cat”. The term “sub-phoneme” as used herein is a portion of a phoneme found by dividing the phoneme into two or three parts.

The term “term” as used herein refers to a sequence of words For example placed in sequence to form a “term” as in for example the “term”; “The Duke of Westminster”, where “Duke” is an example of a “word”.

The term “speech” as used herein refers to unconstrained audio speech. The term “unconstrained” refers to random speech as opposed to prompted responses.

A “phonemic transcription” of a word is a representation of the word comprising a series of phonemes. For example, the initial sound in “cat” and “kick” may be represented by the phonemic symbol ‘k’ while the one in “circus” may be represented by the symbol ‘s’. Further, ‘ ’ is used herein to distinguish a symbol as a phonemic symbol, unless otherwise indicated. In contrast to a phonemic transcription of a word, the term “orthographic transcription” of the word refers to the typical spelling of the word.

The terms “word transcription” or “transcription” as used herein refers to the sequence phonemic transcriptions of a word, or a term including spaces between words

The term “frame” and “phoneme frame” are used herein interchangeably and refers to portions of a speech signal of substantially equal durations or time windows.

The terms “model” and “phoneme model” are used herein interchangeably and used herein to refer to a mathematical representation of the essential aspects of acoustic data of a set of phonemes.

The term “length” as used herein refers to a time duration typically of a “phoneme” or “sub-phoneme”, a “word” or a “term”.

### BRIEF SUMMARY

According to embodiments of the present invention there is provided a computerized method for continuous speech recognition using a speech recognition engine and a phoneme model. The computerized method inputs a speech signal into the speech recognition engine. Based on the phoneme model, the speech signal is indexed by scoring for the phonemes of the phoneme model and a time-ordered list of phoneme candidates and respective scores resulting from the scoring are produced. The phoneme candidates are input with the scores from the time-ordered list. Word transcription candidates are typically input from a dictionary and words are built by selecting from the word transcription candidates based on the scores. A stream of transcriptions is outputted corresponding to the input speech signal. The stream of transcriptions is re-scored by searching for and detecting anomalous word transcriptions in the stream of transcriptions to produce second scores.

The second scores are output and a word building is performed again based on the second scores. A second stream of transcriptions is output based upon the second word building. Statistical information may be received of the scores from a database of word transcriptions. The re-scoring is performed based on the statistical information. The statistical information may include a mean and a standard deviation of the scores and the searching for and detecting of anomalous word transcriptions is performed based on the mean and standard deviation. Alternatively, statistical information is calculated directly from the scores of word transcriptions. The scoring may be frame by frame over a time period for the phonemes of the phoneme model and/or the scoring is for multiple phonemes of the phoneme model over respective lengths or time periods for the phonemes. The indexing and or selection of the word transcriptions may be based on phoneme duration statistics. The phoneme model may explicitly include as a parameter; the length of the phonemes.

According to embodiments of the present invention there is provided a computer readable medium encoded with processing instructions for causing a processor to execute the methods disclosed herein.

### BRIEF DESCRIPTION OF THE DRAWINGS

The invention is herein described, by way of example only, with reference to the accompanying drawings, wherein:

FIG. 1 illustrates a method according to an embodiment of the present invention for generating a phoneme lattice for use in continuous speech recognition.

FIG. 2a illustrates conceptually an example of a phoneme lattice, constructed according to the method of FIG. 1.

FIG. 2b illustrates conceptually another embodiment of a phoneme lattice constructed according to the of FIG. 1.

FIG. 3 which illustrates a method of word building, according to embodiments of the present invention.

FIG. 4 illustrates re-scoring by anomalous detection, according to an aspect of the present invention.

FIGS. 5a and 5b illustrate schematically word scoring/building after anomaly detection of two words “Washington” and “of” respectively.

FIG. 6 illustrates schematically a simplified computer system according to conventional art.

The foregoing and/or other aspects will become apparent from the following detailed description when considered in conjunction with the accompanying drawing figures.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

The embodiments of the present invention may comprise a general-purpose or special-purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone or Personal Digital Assistant “PDA”) where internal modules (such as a memory and processor) work together to perform operations on electronic data.

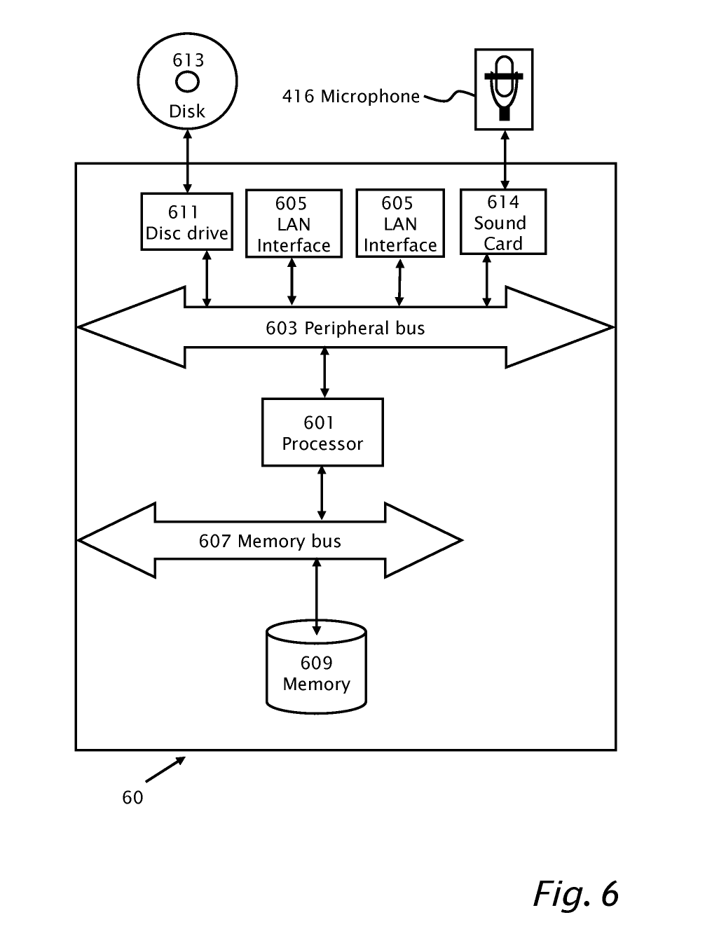

Reference is now made to FIG. 6 which illustrates schematically a simplified computer system 60 according to conventional art. Computer system 60 includes a processor 601, a storage mechanism including a memory bus 607 to store information in memory 609 and a network interface 605 operatively connected to processor 601 with a peripheral bus 603. Computer system 60 further includes a data input mechanism 611, e.g. disk drive for a computer readable medium 613, e.g. optical disk. Data input mechanism 611 is operatively connected to processor 601 with peripheral bus 603. Connected to peripheral bus 603 is sound card 614. The input of sound card 614 connected to the output of microphone 416.

In this description and in the following claims, a “network” is defined as any architecture where two or more computer systems may exchange data. Exchanged data may be in the form of electrical signals that are meaningful to the two or more computer systems. When data is transferred or provided over a network or another communications connection (either hardwired, wireless, or a combination of hardwired or wireless) to a computer system or computer device, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, embodiments of the present invention are directed to a method for performing continuous speech recognition.

A phoneme model is constructed using a speech recognition engine trained on the known phoneme classes of a speech database. A speech database with known phonemes such as TIMIT for the 61 phoneme classes or the folded database of 39 phoneme classes is provided. The phoneme classes are often modeled as state probability density functions for each phoneme. Well known phoneme models include hidden Markov models, Gaussian mixture models and hybrid combinations thereof. After training on the database, the model parameters of the probability distribution functions are determined for each of the phoneme classes.

Construction of a phoneme model appropriate for embodiments of the present invention is disclosed in co-pending U.S. patent application Ser. No. 12/475,879 filed 1 Jun. 2009 by the present inventors. The acoustic data of the phoneme is divided into either two or three sub-phonemes. A parametrized model of the sub-phonemes is built, in which the model includes multiple Gaussian parameters based on Gaussian mixtures and a length dependency such as according to a Poisson distribution. A probability score is calculated while adjusting the length dependency of the Poisson distribution. The probability score is a likelihood that the parametrized model represents the phoneme.

It should be noted that although the methods as disclosed herein include recognition of words the teachings herein are similar applicable to the recognition of “terms” by allowing for the recognition of spaces between the words of the term according to methods known in the prior art. Hereinafter, the “term” and “word” are used interchangeably and the term “word” should be understood as including the meaning of “term”.

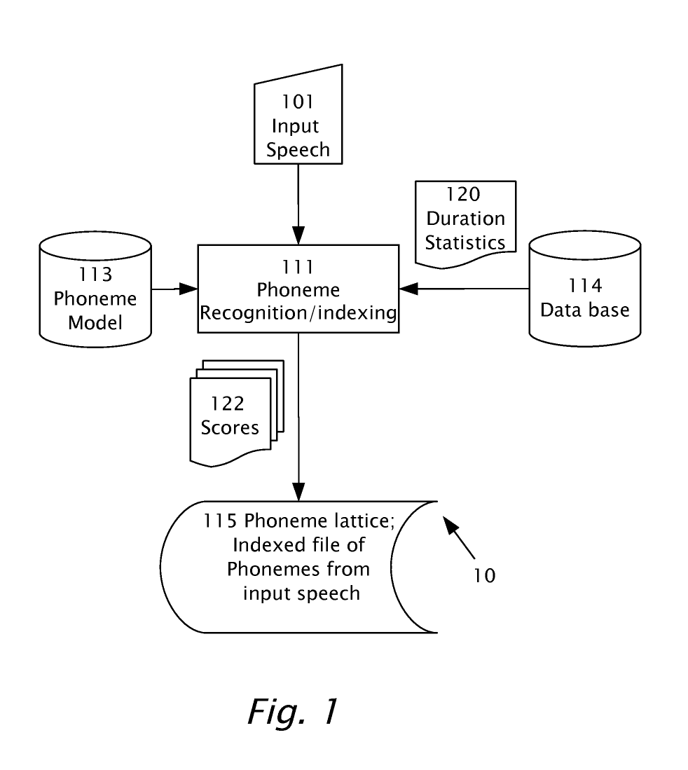

Referring now to the drawings, FIG. 1 illustrates a method 10, according to an embodiment of the present invention for generating a phoneme lattice 115 for use in continuous speech recognition. Phoneme lattice 115 typically represents multiple phoneme hypotheses for a given speech utterance. An input speech signal 101, for instance an unconstrained live speech signal or a previously recorded signal is input into speech recognition engine 111 adapted for recognizing phonemes in input speech signal 101 based on a previously constructed phoneme model 113. Recognition of phonemes in input speech signal 101 by speech recognition engine 111 may utilize duration statistics 120 of phonemes (for example provided by TIMIT) via data base 114. Phoneme lattice 115 includes a time ordered list of phoneme candidates, phoneme durations represented either implicitly or explicitly and scores 122 which indicate the confidence of phoneme recognition. Alternatively or in addition, phoneme lattice 115 may include the number of frames per phoneme candidate and scores 122 per frame. Phoneme lattice 115 may be stored in memory 609.

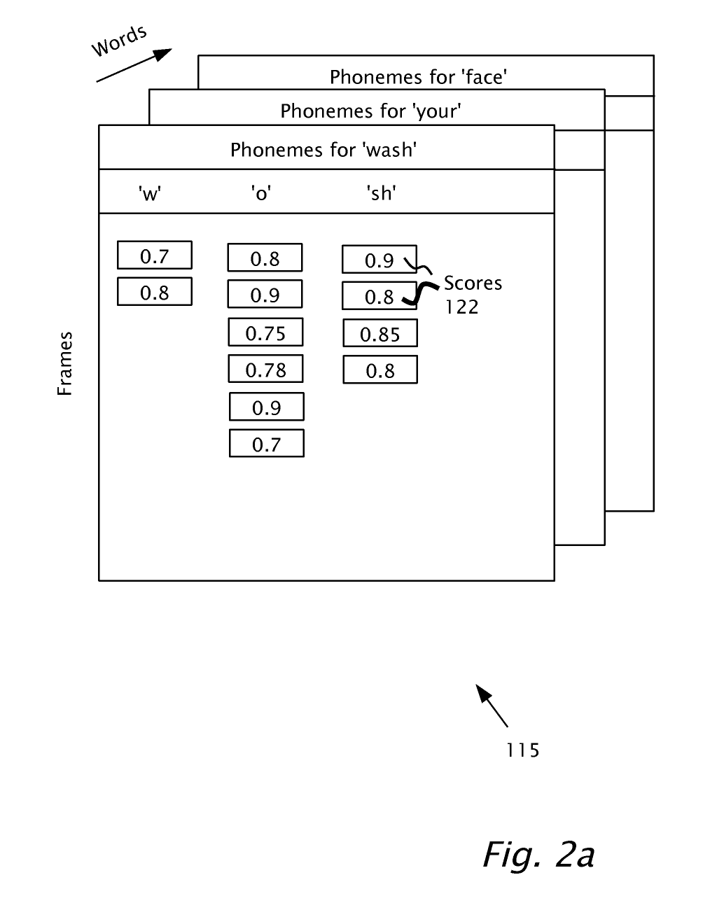

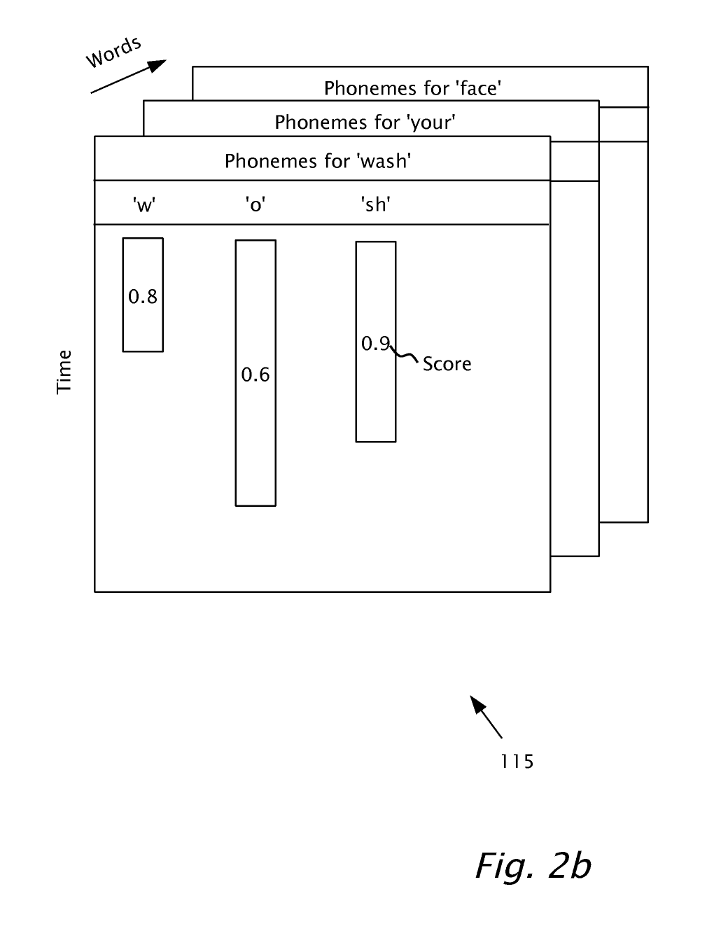

Reference is now also made to FIG. 2a, which illustrates conceptually an example of a phoneme lattice 115, constructed according to method 10 of FIG. 1. Phoneme lattice 115 of FIG. 2a illustrates phonemes recognized frame-by-frame. As an example, spoken words “wash your face” are input as part of input speech signal 101. The expression “wash your face” is shown to have frames stored in time order in phoneme lattice 115 so that the word “wash” is stored first followed by “your” and then “face” with each phoneme stored in a number frames, for instance ‘w′w′o′o′o′o′o′o′sh′sh′sh′sh’ is an example of a phonemic transcription in frames of the word “wash”. The phoneme ‘w’ extends over two frames, the phoneme ‘o’ extends over six frames and the phoneme ‘sh’ extends over four frames. Each frame has a fixed length (of time), therefore, the more frames a phoneme has, the longer the time duration is for each phoneme. Associated with each frame is a frame score 122. The first frame score for ‘w’ is 0.8 followed by the second frame score for ‘w’ as 0.7. The first frame score for ‘o’ is 0.8 and ending with the last frame score 0.7. Likewise the first frame score for ‘sh’ is 0.9 and ending with the last frame score 0.8. Phoneme lattice 115, may include a time ordered list of recognized phoneme candidates optionally with the time duration of the phoneme candidates expressed by the number of frames along with respective frame scores for each frame.

Reference is now also made to FIG. 2b, which illustrates conceptually another embodiment of phoneme lattice 115 constructed according to method 10. Input speech signal 101 is indexed by speech recognition engine 111 according to phoneme length (time duration) with an associated score value. Using the same example, the expression “wash your face” as part of input speech signal 101 includes recognized phonemes stored in time order such that the word “wash” is stored first followed by “your” and then “face”. The phonemes are stored with associated lengths or phoneme durations, shown by vertical bars with time (in milliseconds) along the vertical axis. The recognized phoneme ‘w’ with associated score (0.8) has a shorter length (or time duration) than recognized phoneme ‘o’ with associated score (0.6). Recognized phoneme ‘o’ has a longer length than phoneme ‘sh’ with associated score (0.9). Phoneme ‘sh’ with associated score (0.9) has a longer length than recognized phoneme ‘w’. Phoneme lattice 115, therefore represents a time ordered list of recognized phoneme candidates and respective lengths (time durations) of each recognized phoneme and with respective scores.

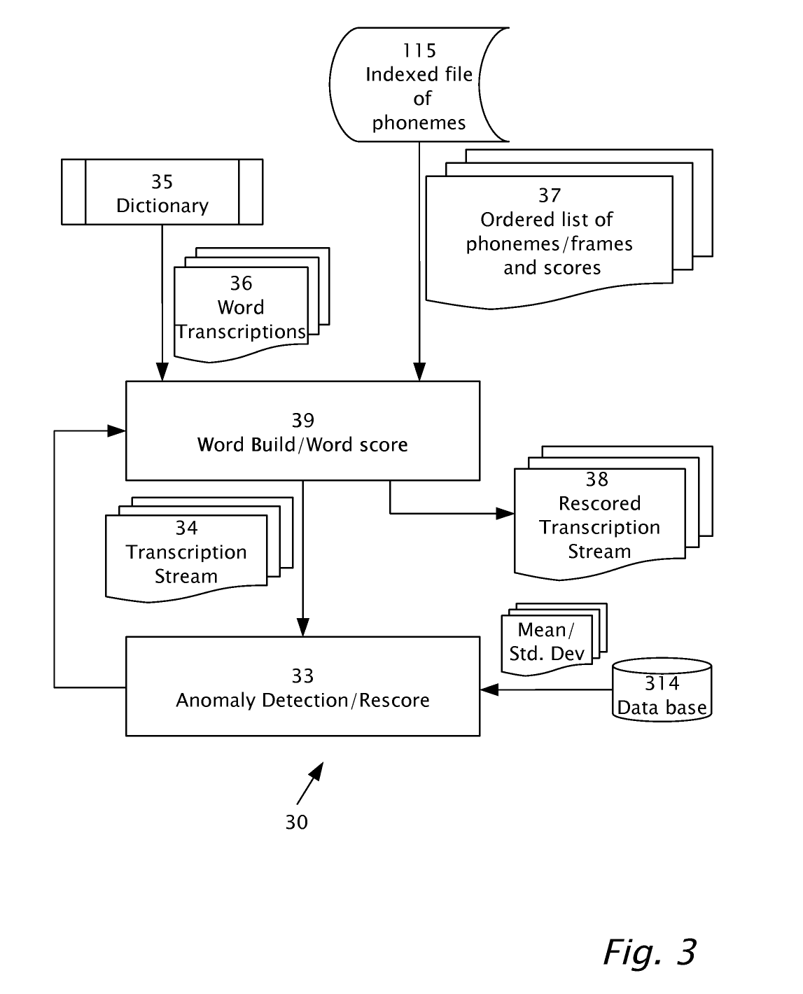

Reference is now also made to FIG. 3, which illustrates a method 30, according to embodiments of the present invention. In a first word building step 39, words are built having as input a time-ordered list of phoneme candidates and scores 37 from phoneme lattice 115 and as another input word transcriptions 36 received from dictionary 35. According to different embodiments of the invention, ordered list 37 may include a list of phonemes including durations and scores per phoneme and/or a list of frames and scores per frame. Word building 39 is performed by comparing word transcription 36 to ordered list 37. The closest matching word transcription 36 is selected based on the phoneme scores input in ordered list 37. The selection may be performed by maximizing candidate word scores found by compounding phoneme and/or frame scores 37 over the candidate word transcriptions 36 as received from dictionary 35.

Alternatively or in addition, word scoring may be performed using duration statistics 120 previously stored in or with phoneme lattice 115 during phoneme recognition 111 (FIG. 1). The output of word building (step 39) is a transcription stream 34 including the selected word transcriptions 36 in time order of input speech signal 101 typically with the best word scores. Transcription stream 34 is selected to have the best correspondence to input speech signal 101, over time or frame number. The word scores of transcription stream 34 after being properly normalized may be considered a time varying probability that word transcriptions 36 match input speech signal 101 on a word by word basis.

According to embodiments of the present invention, transcription stream 34 produced in word building (step 39) is re-scored (step 33) by detecting anomalies in transcription stream 34. Anomaly detection (step 33) may be performed by inputting statistical data, e.g. mean and standard deviation using an external database 314, e.g. TIMIT, of word transcriptions. Alternatively or in addition, statistical data may be calculated from transaction stream 34. In either case, the statistical data word build (step 39) may be performed again based on anomaly detection (step 33) and a re-scored transcription stream 38 is output. Re-scored transcription stream 38 based on anomaly detection typically reflects more accurately the actual words spoken in input speech signal 101 than transcription stream 34.

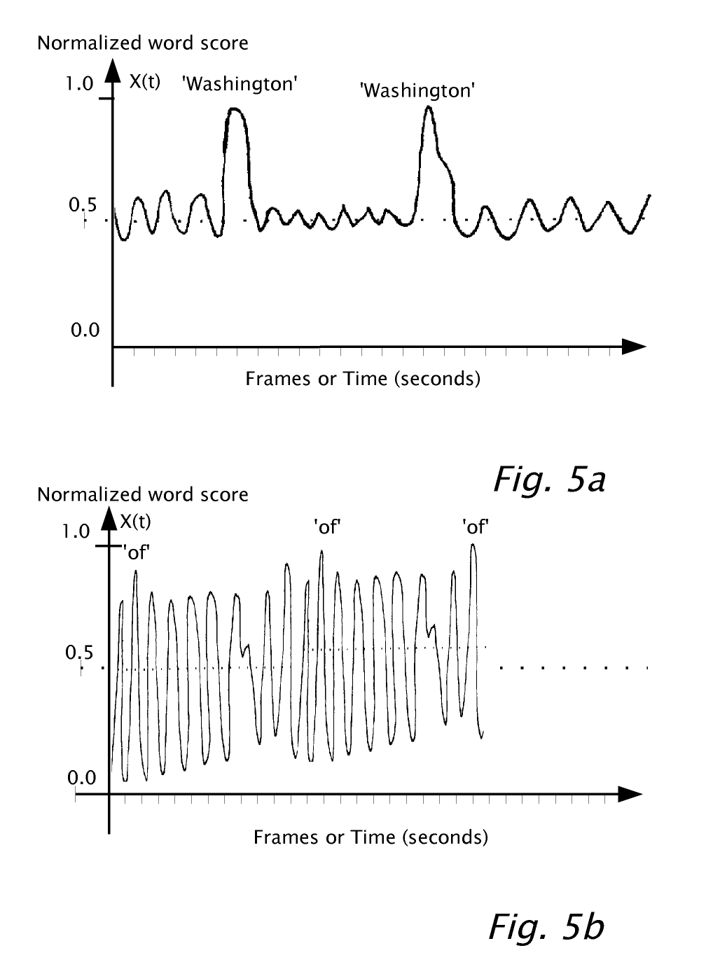

Reference is now made to FIGS. 5a and 5b which illustrate schematically word scoring/building (step 33) after anomaly detection of two words “Washington” in FIG. 5a and “of” in FIG. 5b. The horizontal axes are time or number of frames and the vertical axes are normalized word scores after anomaly detection (step 33) is performed. Two instances of “Washington are marked in the graph of FIG. 5a and three instance of “of” are marked in the graph of FIG. 5b. As can be seen, the word “Washington” is more anomalous than the word “of” and re-scoring based on anomalous detection allows more anomalous words such as “Washington” to be detected more accurately than less anomalous words such as “of”.

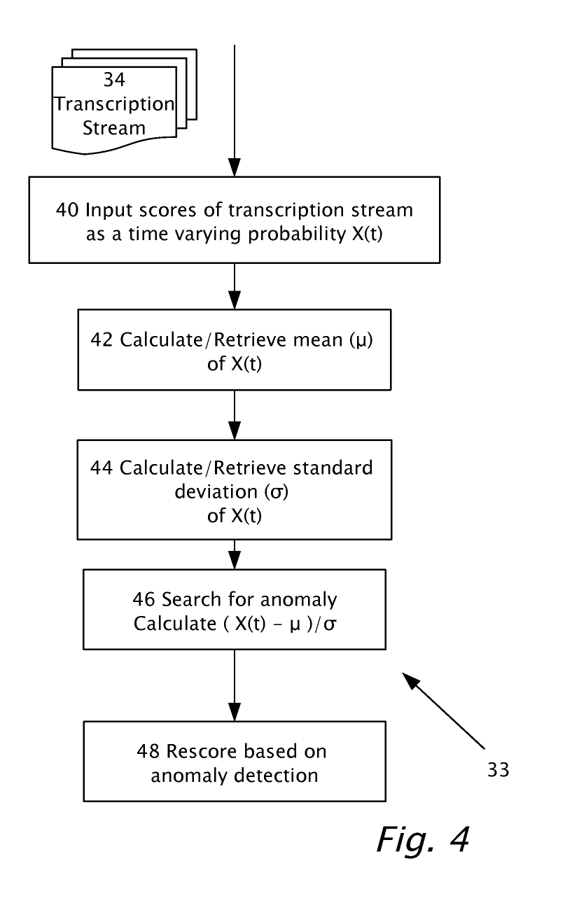

Reference is now made to FIG. 4 which illustrates in more detail re-scoring by anomalous detection (step 33), according to an aspect of the present invention. In step 40, transcription stream 34 is input as a normalized word score X(t). In step 42, mean μ of normalized word score X(t) is calculated from transcription steam 34 or retrieved from data base 314 per word transcription. Similarly, standard deviation σ is either calculated or retrieved in step 44. In step 46, detection of anomalies is performed for instance by subtracting the normalized word scores X(t) from mean μ and dividing the result of the subtraction by standard deviation σ. Standard deviation σ of normalized word scores X(t) is the square root of the variance and is an indicator of variation of the word score X(t) from mean μ of X(t). A small value of standard deviation indicates that the word score X(t) of a particular word or term tends to vary close to mean of X(t), whereas a high value standard deviation indicates that the data points of X(t) are spread out over a large range of values.

The definite articles “a”, “an” is used herein, such as “a phoneme model”, “a speech recognition engine” have the meaning of “one or more” that is “one or more phoneme models” or “one or more speech recognition engines”.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A computerized method for continuous speech recognition using a speech recognition engine and a phoneme model, the computerized method comprising:
inputting a speech signal into the speech recognition engine;
based on the phoneme model, indexing said speech signal by scoring for the phonemes of said phoneme model thereby producing a time-ordered list of phoneme candidates and respective scores resulting from said scoring;
inputting said phoneme candidates and said scores from said time-ordered list;
inputting word transcription candidates from a dictionary;
word building by selecting from said word transcription candidates based on said scores and outputting a stream of transcriptions corresponding to the input speech signal; and
re-scoring said stream of transcriptions by searching for and detecting anomalous word transcriptions in the stream of transcriptions.

2. The method of claim 1, further comprising:
outputting second scores based on said detecting anomalous word transcriptions;
second word building based on said second scores; and
outputting a second stream of transcriptions based upon said second word building.

4. The method of claim 1, further comprising:
receiving statistical information of said scores from a database of word transcriptions, wherein said re-scoring is based on said statistical information.

3. The method of claim 4, wherein said statistical information includes a mean and a standard deviation of said scores and wherein said searching for and detecting anomalous word transcriptions is performed based on said mean and standard deviation

4. The method of claim 1, further comprising:
calculating statistical information directly from said scores of word transcriptions, wherein said re-scoring is based on said statistical information.

5. The method of claim 4, wherein said statistical information includes a mean and a standard deviation of said scores and wherein said searching for and detecting anomalous word transcriptions is performed based on said mean and standard deviation

6. The method of claim 1, wherein said scoring is frame by frame over a time period for the phonemes of said phoneme model.

7. The method of claim 1, wherein said scoring is for a plurality of phonemes of said phoneme model over respective time periods for said phonemes.

8. The method of claim 1, wherein said indexing is based on phoneme duration statistics.

9. The method of claim 1, wherein said selecting is based on phoneme duration statistics.

10. The method of claim 1, wherein said phoneme model explicitly includes as a parameter the length of the phonemes.

11. A computer readable medium encoded with processing instructions for causing a processor to execute the method of claim 1.
